(19) United States
(12) Patent Application Publication
(10) Pub. No.: US 2007/0251233 A1
(43) Pub. Date: Nov. 1, 2007

(54) Method and control unit for adjusting a variable turbocharger turbine flow cross section

(75) Inventors: Albert Bardoll, Rutesheim (DE); Ernst Friedrich Ostertag, Weissach (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG

(21) Appl. No.: 11/789,951

(22) Filed: Apr. 26, 2007

(30) Foreign Application Priority Data
Apr. 26, 2006 (DE) 102006019255.9-13

(51) Int. Cl. F02D 23/00

(52) U.S. Cl. 60/602

(57) ABSTRACT

In a method for actuating an actuating member for adjusting a turbine flow cross section of a turbocharger of an internal combustion engine in a motor vehicle in the event of a change of the load of the internal combustion engine from a relatively low load value to a relatively high load value, the adjustment takes place at least at times by use of the closed-loop control of a scavenging gradient of the internal combustion engine. The method is characterized in that the turbine flow cross section, in the case of a spark-ignition engine as the internal combustion engine, is not fixedly held at a minimum turbine flow cross section between the change of the load and a beginning of an adjustment which is dependent on the scavenging gradient. A control unit is set up and controls the process of such a method.

### CROSS-REFERENCE TO RELATED APPLICATION

This application claims the priority, under 35 U.S.C. §119, of German application DE 10 2006 019 255.9-13, filed Apr. 26, 2006; the prior application is herewith incorporated by reference in its entirety.

### BACKGROUND OF THE INVENTION

Field of the Invention

The invention relates to a control unit for an internal combustion engine in a motor vehicle. The control unit is set up so as to actuate an actuating member for adjusting a turbine flow cross section of a turbocharger of the internal combustion engine in the event of a change of the load of the internal combustion engine from a relatively low load value to a relatively high load value. The adjustment takes place at least at times by use of a closed-loop control of a scavenging gradient of the internal combustion engine. The invention further relates to a method for actuating the actuating member.

A method of this type and a control unit of this type are known in each case from European patent EP 0 870 914 B1.

Turbochargers serve, in a known way, to increase the power of internal combustion engines by pre-compressing the air flowing into the internal combustion engine. The pre-compression permits an increase in combustion chamber charges of the internal combustion engine for given combustion chamber volumes. Since the maximum power is restricted by the combustion chamber charge, the obtainable torque and power levels increase with increasing combustion chamber charges. In turbochargers, the energy required for the pre-compression of the air at the inlet side of the internal combustion engine is taken from the inner energy and kinetic energy of the exhaust gas. The exhaust gas drives a turbine which drives a compressor via a shaft.

The torque generation of an internal combustion engine having a turbocharger generally follows a sudden increase of torque demand with a certain delay, which is also known as turbo lag. The magnitude of the delay is dependent on the moment of inertia of the rotating parts of the turbocharger and on the power transmitted from the exhaust gas to the turbine. The power is determined by the exhaust gas mass flow rate and the enthalpy gradient across the turbine. In the case of spark-ignition engines, use was previously made of conventional turbochargers without adjustable turbine geometry. For closed-loop control of the charge pressure, conventional turbochargers have a bypass flap or waste gate flap which is closed in the event of a positive load change, that is to say in the event of a change of the load from a relatively low to a relatively high load value. This results, with otherwise unchanged operating parameters, in an increased exhaust gas mass flow rate via the turbine.

In turbochargers with an adjustable turbine flow cross section, as have been used in mass production in diesel engines for a long time, the turbine flow cross section is temporarily reduced in the event of a positive load change. This results in a changed build-up behavior of the exhaust gas upstream of the turbine. The exhaust gas back pressure rises and leads, with an initially unchanged exhaust gas mass flow rate, to an increased enthalpy gradient across the turbine.

However, the increased exhaust gas back pressure retroacts, when the exhaust valve is open, on the combustion chamber, and leads there, as per European patent EP 0 870 914, to gas exchange losses and a degradation of the efficiency of the internal combustion engine. As an undesired result, European patent EP 0 870 914 states a sub-optimum level of fuel consumption and an increased probability of the occurrence of undesired air-deprived combustions, which are associated with smoke generation.

In order to remedy this, European patent EP 0 870 914 B1 proposes in this context to reduce the turbine flow cross section to a minimum turbine flow cross section in the event of a positive load change, and to hold the turbine flow cross section there during a closure time until a continuously determined operating parameter reaches a predetermined nominal value. The closure takes place with the aim of a rapid increase of the torque. The turbine flow cross section should subsequently be continuously enlarged again. After the closing phase in which, according to an embodiment of the method of EP 0 870 914, the target value of the fuel quantity to be injected and therefore the target value of the torque is to be reached already, European patent EP 0 870 914 B1 provides, in a further embodiment, to open the turbine flow cross section by use of a closed-loop control circuit, with a differential pressure between a charge pressure in the inlet tract and an exhaust gas pressure (exhaust gas back pressure) in the exhaust tract of an internal combustion engine being determined and adjusted by closed-loop control to a nominal value. The differential pressure constitutes the so-called scavenging gradient.

According to European patent EP 0 870 914, the adjustment by closed-loop control to the predefined nominal differential pressure during dynamic operation has the effect that the scavenging gradient between the outlet tract and the inlet tract of the internal combustion engine is held in a favorable range with regard to the efficiency of the internal combustion engine. Gas exchange losses caused by an excessively high exhaust gas back pressure in relation to the charge pressure, which excessively high exhaust gas back pressure must first be overcome by the pistons of the internal combustion engine when discharging the exhaust gases, should be reduced to a minimum by the adjustment by closed-loop control of a certain scavenging gradient.

In other words: the closed-loop scavenging gradient control according to European patent EP 0 870 914 takes place, in the event of a demand for a higher torque, only in a second phase, and there with the aim of efficiency optimization. In the subject matter of European patent EP 0 870 914, the actual torque build-up phase takes place in a first phase in which the turbine flow cross section is set and fixedly held, without closed-loop control, at a minimum cross section.

Turbochargers with variable turbine geometry have hitherto been used in mass production only in diesel engines. Even if spark-ignition engines have hitherto been operated, on account of relatively high exhaust gas temperatures, with turbochargers which have a fixed turbine geometry, it can be expected that using turbochargers with variable turbine geometry in spark-ignition engines will in principle likewise have a positive effect on the undesired turbo lag effect. The positive effects observed during tests, however, fall short of expectations. A non-uniform torque profile in positive load changes has in fact been observed, which adversely affects drivability.

### SUMMARY OF THE INVENTION

It is accordingly an object of the invention to provide a method and a control unit for adjusting a variable turbocharger turbine flow cross section which overcome the above-mentioned disadvantages of the prior art methods and devices of this general type, with which it is possible to obtain an accelerated and more uniform torque build-up of a spark-ignition engine as an internal combustion engine in the event of a positive load change.

With the foregoing and other objects in view there is provided, in accordance with the invention, a method for actuating an actuating member for adjusting a turbine flow cross section of a turbocharger of an internal combustion engine in a motor vehicle in an event of a change of a load of the internal combustion engine from a relatively low load value to a relatively high load value. The method includes performing the adjusting at least at times by closed-loop control of a scavenging gradient of the internal combustion engine, and not fixedly holding the turbine flow cross section at a minimum turbine flow cross section between a change of the load and a beginning of an adjustment being dependent on the scavenging gradient if the internal combustion engine is a spark-ignition engine.

According to the invention, the turbine flow cross section is not initially adjusted to and fixedly held at a minimum turbine flow cross section between the positive load change and the beginning of a closed-loop scavenging gradient control adjustment, the invention provides the inverse of the teaching of European patent EP 870 914 B1. The invention recognizes that the-build-up of the exhaust gas back pressure upstream of the turbine, which is itself desired and is generated according to the known approach, can have a counterproductive effect in a spark-ignition engine. This arises from the fact that spark-ignition engines are operated in a throttled manner in the part-load region, while diesel engines are generally operated largely unthrottled in the region. For explanation, the conditions in diesel engines and spark-ignition engines are considered in more detail below.

At part-load, the diesel engine operates with an excess of air. The desired torque is set by the metered fuel quantity, which is also referred to as quality control. As a result, the diesel engine therefore outputs a comparatively high exhaust gas mass flow rate, which increases the turbine rotational speed, even in the part-load range in which it generates only little torque. Setting a minimum turbine flow cross section then leads practically without a delay to an increased level of turbine power, an increased charge pressure and therefore to a fast increase of the combustion chamber charges and of the torque of the diesel engine.

The power of the spark-ignition engine, in contrast, is generally set by the quantity of the mixture burned in the combustion chambers, which is also referred to as quantity control. This applies at least to spark-ignition engines with external mixture formation (for example by intake pipe injection) and spark-ignition engines with gasoline direct injection in the so-called homogeneous mode. At low levels of power, that is to say at low torques and/or rotational speeds, there is then also only a correspondingly low exhaust gas mass flow rate.

In operating states with low exhaust gas mass flow rates, the turbine rotational speed therefore falls comparatively suddenly in charged spark-ignition engines. Although setting a minimum turbine flow cross section then likewise increases the build-up of the exhaust gases upstream of the turbine, on account of the low exhaust gas mass flow rate, this is however not associated with a large rise in the turbine power in absolute in the first moment.

The air expenditure of the spark-ignition engine is however adversely affected by the sharply rising exhaust gas back pressure. Here, air expenditure is to be understood as the air density in the combustion chamber normalized to an air density in the intake pipe. If the swept volume of a spark-ignition engine is for example 1,000 cm³ and the spark-ignition engine uses, in one working cycle, 1.2 g of air at an air density in the intake tube of 1.2 g/dm³, the air expenditure is equal to 1. A sharply rising exhaust gas back pressure leads to an increased residual gas quantity in the combustion chambers and thereby hinders the charging of the combustion chambers with unburned mixture or air, which undesirably reduces the air expenditure.

As a result, as a primary undesired result in the first moments after a positive load step, the torque of the engine is reduced in relation to the value theoretically possible without charging as “intake full load” or with a large turbine cross section. This is perceived by the driver as very disturbing. As a secondary result, there is a reduction in the exhaust gas mass flow rate which is available to the turbine. The reduction can be so intense that, despite the increased build-up, the energy available to the turbine is lower than with a turbine flow cross section which is not reduced to a maximum degree, so that, in addition to the torque losses in the first moment, there is also a slower overall charge pressure and torque rise.

The invention serves to minimize the undesired effects. The adjustment of the turbine flow cross section takes place without setting and holding a minimum turbine flow cross section. The adjustment also takes place by closed-loop control of the scavenging gradient, since this variable, in contrast to the absolute exhaust gas back pressure, is the determining variable for a degradation of the combustion chamber charging as a result of an excessively intense build-up of the exhaust gases upstream of the turbine.

Here, the closed-loop control of the scavenging gradient takes place with the aim of providing as far as possible approximately the intake full load torque from the beginning of the load step onwards, and at the same time to increase the rotational speed of the turbocharger, and therefore the charge pressure, as quickly as possible.

A minimization of gas exchange losses, as is sought in European patent EP 0 870 914, is of secondary importance here. In contrast to the subject matter of European patent EP 0 870 914, practically the entire torque build-up takes place under the influence of the closed-loop scavenging gradient control which is configured for a rapid torque build up.

As a result, the torque provided by the spark-ignition engine then increases significantly faster and more uniformly in the event of a positive load change than would be the case by intermediately setting and fixedly holding a minimum turbine flow cross section.

The same advantages result for corresponding embodiments of the control unit.

It is self-evident that the features specified above and the features yet to be explained below can be used not only in the respectively specified combination but also in other combinations or individually without departing from the scope of the present invention.

Other features which are considered as characteristic for the invention are set forth in the appended claims.

Although the invention is illustrated and described herein as embodied in a method and a control unit for adjusting a variable turbocharger turbine flow cross section, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, illustration of a spark-ignition engine having a turbocharger with a variable turbine geometry according to the invention;

FIG. 2 is a diagrammatic illustration of a variation of the turbine geometry;

FIG. 3 is block circuit diagram of a closed-loop control circuit for the closed-loop control of the scavenging gradient; and

FIGS. 4A-4D are graphs showing time profiles of a driver demand, a throttle flap adjustment and adjustments of a turbine flow cross section in the event of a positive load change.

### DESCRIPTION OF THE PREFERRED EMBODIMENTS

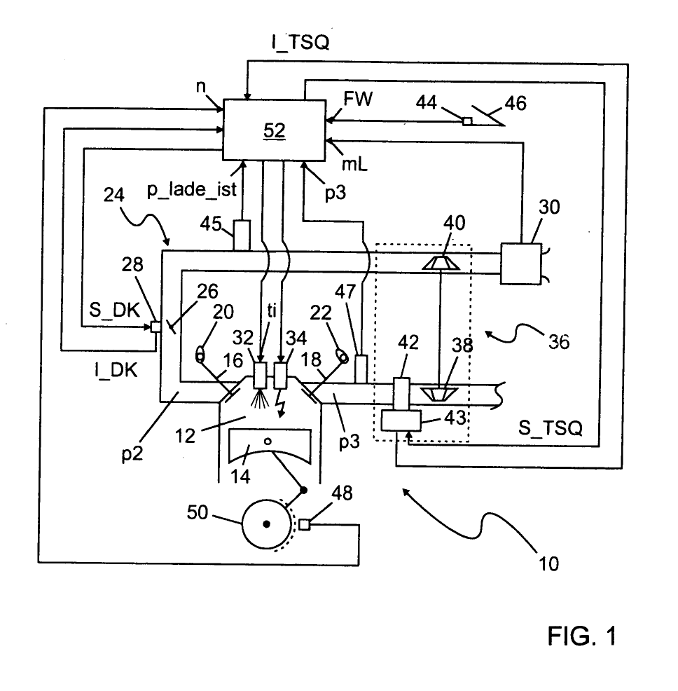

Referring now to the figures of the drawing in detail and first, particularly, to FIG. 1 thereof, there is shown an internal combustion engine 10 having at least one combustion chamber 12 which is moveably sealed off by a piston 14. A charge exchange of the combustion chamber 12 is controlled by an intake valve 16 and an exhaust valve 18, with the intake valve 16 being actuated by an intake valve adjuster 20 and the exhaust valve 18 being actuated by an exhaust valve adjuster 22. In one embodiment, the intake valve adjuster 20 controls the intake valve 16 with a variable lift, and thus serves as a charge adjusting member.

When the intake valve 16 is open, air or a mixture of air and fuel flows from an intake system 24 into the combustion chamber 12. The quantity of air flowing in or of mixture flowing in is adjusted, alternatively or in addition to a variation of a lift of the intake valve 16, by a throttle flap 26 which is actuated by a throttle flap adjuster 28. In any case, the combustion chamber charging is influenced here decisively by a pressure p2 upstream of the intake valve 16. In one embodiment, the throttle flap adjuster 28 has an integrated throttle flap sensor which provides an item of information I_DK regarding an actual value of an opening angle of the throttle flap 26.

The combustion chamber charge is preferably determined from the signal of a charge sensor 30 which can be embodied as an air mass sensor or an intake pipe sensor. The charge can thus for example be determined as an intake air mass ml which is normalized to the rotational speed and number of cylinders. It is self-evident that an intake pipe sensor can also be provided in addition to an air mass sensor. The fuel is either metered into the intake system 24 (intake pipe injection) or is injected through an injector 32 directly into the combustion chamber 12 (direct injection).

In any case, a combustible combustion chamber charge is generated in the combustion chamber 12, which combustion chamber charge is ignited by a spark plug 34. Residual gases of the burned charge of the combustion chamber 12 are discharged via the open exhaust valve 18. Here, a pressure p3 which is dependent on the exhaust gas mass flow rate and on the turbine flow cross section of a turbocharger 36 is generated downstream of the exhaust valve 18.

The turbocharger 36 illustrated in FIG. 1 has a turbine having a turbine wheel 38 which is driven by the discharged exhaust gases. The turbine drives a compressor wheel 40 in the intake system 24. The turbocharger 36 also has an adjusting member 42 with an electric drive 43 for controlling the geometry of the turbocharger 36. The electric drive 43 is typically an electric motor which, in connection with a mechanism of the adjusting member 42, generates a rectilinear or curved adjusting movement. A charge pressure p_lade_ist generated by the turbocharger 36 is measured by a charge pressure sensor 45.

Torque demands FW of a driver are measured by a driver demand transducer 44 which measures the position of an accelerator pedal 46 of the motor vehicle. A rotational angle sensor 48 reads angle marks of a transducer wheel 50 which is rotationally fixedly connected to a crankshaft of the spark-ignition engine 10, and thereby provides an item of information regarding the angular position and the angular speed of the crankshaft. The angular speed is a measure of the rotational speed n of the spark-ignition engine 10.

It is self-evident that, for the open-loop and/or closed-loop control of the spark-ignition engine 10 in modern motor vehicles, a plurality of further sensors can be present which measure pressures, temperatures, angular positions of camshafts and/or further operating parameters of the spark-ignition engine 10. The invention is therefore not restricted to use in a spark-ignition engine 10 which has only the above-specified sensors 28, 30, 44, 45, 48. It is thus possible, in one embodiment, for the adjusting member 42 to provide an item of information I_TSQ regarding an adjusted guide blade position, that is to say position feedback for closed-loop control of the guide blade position in a closed loop or for modeling the pressure p3 or a self-diagnostic result. For one embodiment of the invention, the spark-ignition engine 10 has a second pressure sensor 47 which measures the exhaust gas back pressure p3 between the turbine 38 and the exhaust valve 18.

In order to control the spark-ignition engine 10, the signals of the integrated throttle flap sensor 28, of the charge sensor 30, of the driver demand transducer 44, of the rotational angle sensor 48, of the charge pressure sensor 45, of the second pressure sensor 47 if present, the optionally present item of information I_TSQ and if appropriate the signals of alternative or further sensors are processed by a control unit 52 which is set up, in particular programmed, to control the process of the method according to the invention and/or of one or more of its embodiments. The control unit 52 is characterized in particular in that, from the received items of information and signals, it forms actuating signals for controlling functions of the spark-ignition engine 10. In the embodiment of FIG. 1, the actuating signals are substantially throttle flap actuating signals S_DK and signals S_TSQ with which the control unit 52 controls a turbine flow cross section, and also injection pulse widths ti and ignition signals.

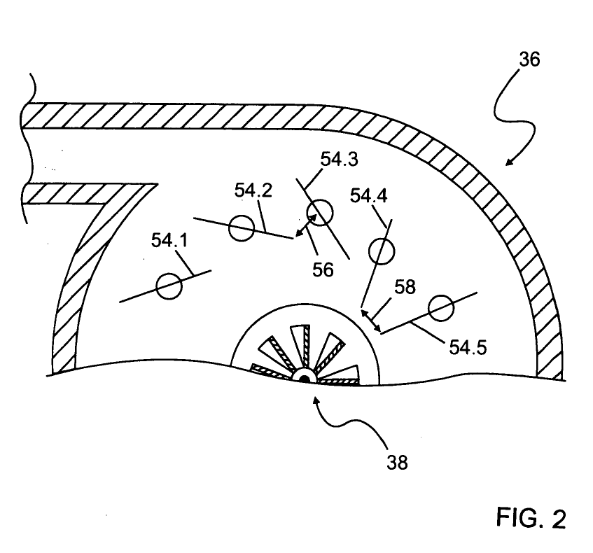

FIG. 2 shows an embodiment of a turbine of the turbocharger 36 having annularly disposed guide blades 54.1, 54.2, 54.3, 54.4 and 54.5. Unlike reality, in which all the guide blades 54.1, 54.2, 54.3, 54.4 and 54.5 are adjusted together, the guide blades 54.1, 54.2 and 54.3 are illustrated in a closed position with a small flow cross section 56, and the guide blades 54.4 and 54.5 are illustrated in a more open position with a larger flow cross section 58. The base charge pressure is illustrated here with the larger flow cross section 58. The adjustment is carried out by the adjusting member 42 which, for example, actuates an adjusting ring which is connected by moveable levers to the guide blades. Details of the mechanism are not essential to the invention.

In FIG. 1, the control unit 52 as a closed-loop controller forms, together with the adjusting member 42 as a closed-loop adjusting member, the internal combustion engine 10 as a closed-loop control path and the two pressure sensors 45, 47 as actual value sensors, a closed-loop control circuit for the closed-loop control of the scavenging gradient p3-p2.

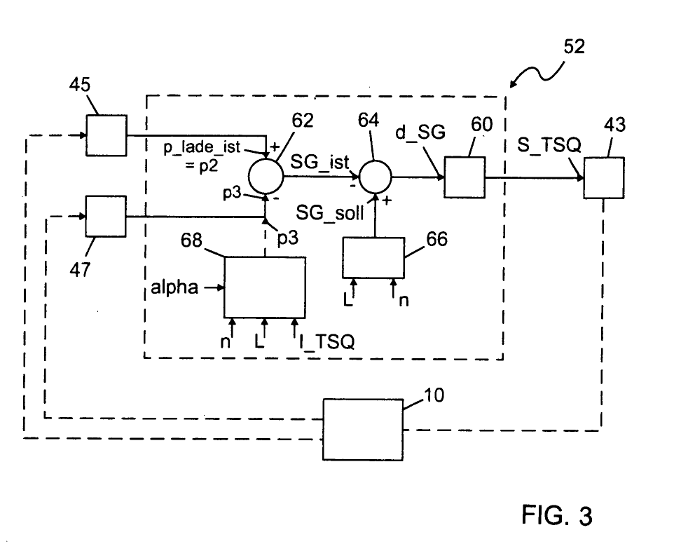

A closed-loop control circuit of the type is illustrated schematically in FIG. 3. The control unit 52 has a closed-loop scavenging gradient controller 60 which forms and outputs the actuating variable S_TSQ for adjusting the turbine flow cross section. The turbine flow cross section which is set as a result manifests itself, via reactions of the spark-ignition engine 10, in values of the charge pressure p2 and the exhaust gas back pressure p3. The actual value p_lade_ist is measured by the charge pressure sensor 45 and is passed as a pressure p2 to the control unit 52. The equalization of p_lade_ist and p2 is permitted when the throttle flap 26 is largely open. The actual value p_abg_ist for the exhaust gas back pressure p3 is, in a first embodiment, provided by the second pressure sensor 47 and passed to the control unit 52. At a junction 62, an actual value SG_ist of the scavenging gradient is formed by subtracting the exhaust gas back pressure p3 from the charge pressure p2. Under the considered boundary conditions of a positive load change, in which an increased charge pressure should be provided as quickly as possible, the throttle flap 26 is generally fully open, so that the actual value p_lade_ist measured upstream of the throttle flap can be set equal to the pressure p2 upstream of the intake valves 16 of the spark-ignition engine 10.

At a further junction 64, a closed-loop control error d_SG is formed from the actual value SG_ist of the scavenging gradient and a nominal value SG_soll of the scavenging gradient, which closed-loop control error d_SG serves as an input variable for the closed-loop controller 60. The nominal value SG_soll, which is an optimum value for a fast torque build-up, varies only to a small degree and can therefore be regarded as a constant or determined as a function of a small number of operating parameters of the spark-ignition engine. In the embodiment illustrated in FIG. 3, the nominal value SG_soll is determined by a characteristic diagram 66 which is addressed with the load L and the rotational speed n of the spark-ignition engine 10.

The load L of the spark-ignition engine 10 is generated, in one embodiment, as an actual combustion chamber charge, as can be determined from measured values for the air mass mL flowing into the spark-ignition engine 10 and the rotational speed n incorporating the number of combustion chambers, normalized to a maximum possible combustion chamber charge. In another embodiment, the load is generated as a mean pressure in the combustion chamber during a working stroke or as an actual value of the torque provided by the spark-ignition engine 10. Both the mean pressure and the actual value of the torque can in principle be determined by the control unit 52 from measured operating parameters.

Alternatively to measuring the pressures p2, p3, one of the two pressures or else both pressures or the scavenging gradient itself can be directly determined by a mathematical model from other operating parameters of the spark-ignition engine 10. Significant operating parameters in this context are the present value of the turbine flow cross section and all operating parameters which influence the size and temperature of the exhaust gas mass flow rate. Here, too, the rotational speed n and the load L are again significant influential variables. With regard to the exhaust gas temperature, the ignition angle alpha formed in the control unit also plays a role.

The position feedback signal I_TSQ can be used as a measure for the turbine flow cross section. The block 68 represents an embodiment in which the pressure p3 is calculated by use of a model in the control unit. With sufficiently precise calculation of the pressure p3, the pressure sensor 47 can be dispensed with. Alternatively, the modeled pressure p3 can also be used for modeling faster pressure changes, with the measured pressure p3 being used to adapt the model in the event of less fast pressure changes. Even though, for reasons of clarity, not all of the sensors illustrated in FIG. 1 are depicted in FIG. 3, for comprehension of FIG. 3, it should be assumed that the signals of the sensors are present in the control unit 52 and can thereby be used, for example, for addressing the blocks 66 and 68.

In one embodiment, the closed-loop controller 60 is embodied as a classic PI-type closed-loop controller with a proportional component (P-component) and an integral component (I-component). However, the invention is not restricted to PI-type closed-loop control, but can use, for the closed-loop control, any method which, from a nominal-value/actual-value comparison, forms a closed-loop control actuating variable S_TSQ which manifests itself via the spark-ignition engine 10 as a closed-loop control path in the actual value SG_ist, and leads to an approximation of the actual value SG_ist to the nominal value SG_soll.

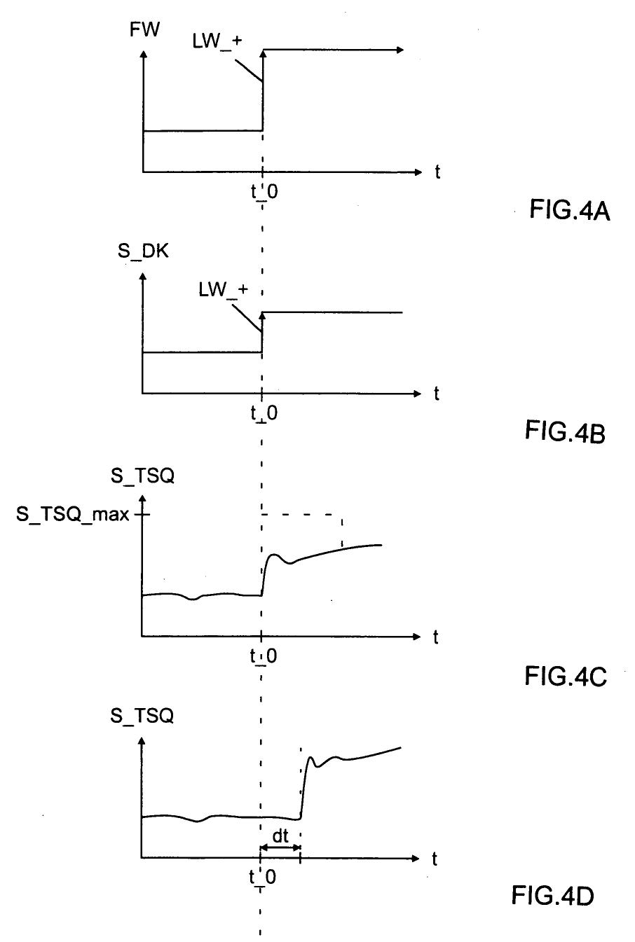

FIGS. 4A-4D show in qualitative form, time profiles of different operating parameters during the progression of an embodiment of the method. FIG. 4A shows a time profile of a driver demand FW in the event of a positive load change LW_+ which occurs at a time t_0. Here, a high value of FW corresponds to a high desired torque. The control unit 52 processes the signal FW and forms actuating signals S_DK and S_TSQ for generating the desired higher torque.

In order to generate the higher torque, in particular the throttle flap 26 is opened quickly. This is shown in FIG. 4B by the rise of the actuating signal S_DK, with which the throttle flap 26 is opened further, directly following the positive load change LW_+. With alternative or additional control of the combustion chamber charges by a variation of the lift of the intake valve 16, the lift of the intake valve is correspondingly increased.

FIG. 4C shows a possible profile of an actuating signal S_TSQ for the turbine flow cross section as is generated when using an embodiment of a method according to the invention. Here, a high value of S_TSQ corresponds to the setting of a small turbine flow cross section. In this embodiment, the described closed-loop scavenging gradient control is begun immediately at the time t_0 of the positive load change LW_+. The illustrated profile of the turbine flow cross section actuating signal S_TSQ mirrors this in qualitative terms. In contrast to European patent EP 0 870 914, the guide blades are in particular not moved to a minimum opening cross section, and are not held at the minimum opening cross section. In the method known from European patent EP 0 870 914, S_TSQ would correspond qualitatively to the profile illustrated by dashed lines in FIG. 4C, wherein S_TSQ_max would lead to the setting of a minimum turbine flow cross section. The invention can also utilize an intermediate value of the actuating signal S_TSQ, which between the value valid directly before the time t_0 and the maximum value S_TSQ_max, as a starting value for the closed-loop control. It is however important that the start value does not correspond to the maximum value S_TSQ_max, but is rather for example a maximum of 80% of said value.

FIG. 4D shows a further embodiment, in which an actuation, which is dependent on the scavenging gradient, of the actuating member 42 takes place with a delay dt in relation to the change LW_+ of the load L.

As a result of the delay, which occurs in this embodiment, of the actuation of the adjusting member, the exhaust gas mass flow rate can initially be increased with the throttle flap 26 open. If, after the short delay time has expired, an initial closing adjustment by the closed-loop scavenging gradient control takes place, then an increased exhaust gas mass flow rate is already available, so that the exhaust gas energy transmitted to the turbine is significantly greater than in the case of an adjustment without a delay. The embodiment also reduces or prevents degradations of the air expenditure in the event of a positive load change.

Here, a magnitude of the delay dt can be predefined as a function of at least one operating parameter of the spark-ignition engine 10. The delay timespan dt typically corresponds to the time duration of a small number of working cycles of the spark-ignition engine 10 in which, for example, 2-10 increased combustion chamber charges are discharged. The spark-ignition engine 10 is then operated during the delay timespan dt with an increased signal S_DK but not yet with an increased signal S_TSQ. The length of the delay timespan dt can, in one simple embodiment, be predefined as a fixed value. It is however preferable for the magnitude of the delay, that is to say the length of the timespan dt, to be predefined as a function of at least one operating parameter of the spark-ignition engine 10. For this purpose, in particular the rotational speed n of the spark-ignition engine 10 is conceivable as an operating parameter in the event of a positive load change LW_+. The higher the rotational speed n, the higher the exhaust gas mass flow rate, as a variable which is proportional to the number of burned combustion chamber charges generated per unit time.

In one particular spark-ignition engine 10, for example, a delay timespan dt of 200 ms at n=2,000 rev/min and a delay timespan dt of 50 ms at n=6,000 rev/min have proven to be optimal. In a six-cylinder engine having in each case one turbocharger for every three cylinders, in said 50 ms, for example, exhaust gases of (50*3*6,000)/(1,000*60), that is to say of 7 to 8 combustion chamber charges are discharged. In general, the magnitude of the delay is fixed at higher values at a smaller value of the rotational speed n than at a higher value of the rotational speed.

However, the exhaust gas mass flow rate is dependent not only on the number of combustion chamber charges per unit time but also on the size of the individual combustion chamber charges. In a further preferred embodiment, when fixing the value of the delay timespan dt, the control unit 52 incorporates as a further operating parameter a load L of the spark-ignition engine 10 before the positive load change LW_+. Here, the magnitude of the delay dt is fixed at higher values at a smaller value of the load L than at a higher value of the load L.

Within the context of a further embodiment, it is provided that the closed-loop scavenging gradient control is carried out only in first operating states including in particular dynamic operating states after a positive load change LW_+. Here, in second operating states, the turbine flow cross section is adjusted in a closed-loop control circuit with the charge pressure p_lade_ist as the variable to be controlled. The second operating states are preferably steady-state operating states.

Also provided is a function which, regardless of a closed-loop scavenging gradient control action, prevents setting of an undesirable excessively high charge pressure. A function of this type can for example take place by a closed-loop charge pressure control action, open-loop charge pressure control action or charge pressure limitation, which takes place parallel to the closed-loop scavenging gradient control action and which generates an alternative value of the actuating variable of the turbine flow cross section. The prevention of the excessively high charge pressure then takes place by a maximum value selection between the turbine flow cross sections which would be set by the closed-loop scavenging gradient control action and the closed-loop charge pressure control action, open-loop charge pressure control action or charge pressure limitation taking place in parallel. Here, always the larger of the two cross sections is set.

Directly after a positive load change, a P-component of a PI-type closed-loop control action would, for example, demand a small turbine flow cross section which is counterproductive for torque generation, while the closed-loop scavenging gradient control action would demand a larger turbine flow cross section with regard to an optimum scavenging gradient for torque generation. The maximum value then ensures that the counterproductive small flow cross section is not set. If the charge pressure, in contrast, threatens to undesirably rise sharply at an optimum scavenging gradient, the closed-loop charge pressure control action will demand the larger cross section, and the maximum value selection will permit the larger cross section.

We claim:

1. A method for actuating an actuating member for adjusting a turbine flow cross section of a turbocharger of an internal combustion engine in a motor vehicle in an event of a change of a load of the internal combustion engine from a relatively low load value to a relatively high load value, which comprises the steps of:
performing the adjusting at least at times by closed-loop control of a scavenging gradient of the internal combustion engine; and
not fixedly holding the turbine flow cross section at a minimum turbine flow cross section between a change of the load and a beginning of an adjustment being dependent on the scavenging gradient if the internal combustion engine is a spark-ignition engine.

2. The method according to claim 1, which further comprises determining an actual value of the scavenging gradient as a difference of a measured charge pressure value and an exhaust gas back pressure prevailing upstream of the turbine flow cross section as viewed in a flow direction of exhaust gases of the spark-ignition engine.

3. The method according to claim 2, which further comprises modeling the exhaust gas back pressure from operating parameters of the spark-ignition engine.

4. The method according to claim 3, which further comprises measuring the exhaust gas back pressure.

5. The method according to claim 3, which further comprises:
measuring the exhaust gas back pressure; and
using measured values of the exhaust gas back pressure for adapting modeled values of the exhaust gas back pressure.

6. The method according to claim 1, which further comprises performing the actuation, which is dependent on the scavenging gradient, of the actuating member with a delay in relation to a change of the load.

7. The method according to claim 6, which further comprises predefining a magnitude of the delay as a function of at least one operating parameter of the spark-ignition engine.

8. The method according to claim 1, which further comprises in steady-state operating states of the spark-ignition engine, adjusting the turbine flow cross section by use of a closed-loop control circuit and a charge pressure as a variable to be controlled.

9. A control system for an internal combustion engine in a motor vehicle, the control system comprising:
a control unit for actuating an actuating member for adjusting a turbine flow cross section of a turbocharger of the internal combustion engine in an event of a change of a load of the internal combustion engine from a relatively low load value to a relatively high load value, the adjusting taking place at least at times by closed-loop control of a scavenging gradient of the internal combustion engine, said control unit being set up so as not to fixedly hold the turbine flow cross section, in a case of a spark-ignition engine as the internal combustion engine, at a minimum turbine flow cross section between a change of the load and a beginning of an adjustment being dependent on the scavenging gradient.

10. The control system according to claim 9, wherein said control unit determines an actual value of the scavenging gradient as a difference of a measured charge pressure value and an exhaust gas back pressure prevailing upstream of the turbine flow cross section as viewed in a flow direction of exhaust gases of the spark-ignition engine.
